(19) United States
(12) Patent Application Publication
(10) Pub. No.: US 2007/0027895 A1
(43) Pub. Date: Feb. 1, 2007

(54) Systems and methods for providing customized multi-function device interfaces using user authentication

(75) Inventors: Amanda Kay Bridges, Winchester, KY (US); William James Gardner Flowers, Lexington, KY (US); Charles Edward Grieshaber, Versailles, KY (US); Chad Eugene McQuillen, Lexington, KY (US); Michael Ray Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/191,130

(22) Filed: Jul. 27, 2005

(51) Int. Cl. G06F 7/00

(52) U.S. Cl. 707/102

(57) ABSTRACT

Systems, methods and apparatuses of the present invention enable customized user interfaces and storage based on the identity of a user. After authenticating a user, the multifunction device will present a user with objects, such as print jobs, associated with the user. The consumer may also be presented with an automatically generated container containing all objects associated with the user. Additionally, graphical user interface icons associated with user objects may be prioritized in a graphical user interface that displays default information.

### FIELD OF THE INVENTION

The present invention relates generally to multi-function devices, and more particularly, to systems and methods that provide a user with customized interfaces for accessing documents, jobs, and features of a multi-function device based on user-authentication.

### BACKGROUND OF THE INVENTION

Conventional systems and networks including multi-function devices providing scan, copy, print, and fax features often include methods for authenticating users. These authentication methods typically involve a user name associated with a password. Based on this information, additional stored information may be retrieved, such as a user's full name, email address, phone number(s), fax number(s), and the like. As an example, a server implementing Lightweight Directory Access Protocol (LDAP) may, based on a user name and password, use a unique identifier for an individual to identify information stored about an individual. Similar methods of authentication in the NT domain, Kerberos, and the like, are known.

Unfortunately, however, conventional multi-function devices fail to provide features that take advantage of user authentication. For instance, multi-function devices typically do not provide customized user-interfaces, storage, and search capabilities based on the identity of a user. Therefore, what is needed are multi-function devices that provide users with customized experiences in interacting with a multi-function device, including customized interfaces for enabling the quick and efficient storage, retrieval and search for documents, print jobs, and the like.

### BRIEF SUMMARY OF THE INVENTION

Systems, methods and apparatuses of the present invention enable customized user interfaces and storage based on the identity of a user. After authenticating a user, the multifunction device will present a user with objects, such as print jobs, associated with the user. The consumer may also be presented with an automatically generated container containing all objects associated with the user. Additionally, graphical user interface icons associated with user objects may be prioritized in a graphical user interface that displays default information.

According to one embodiment of the invention, there is disclosed a method for presenting user-customized graphical user interfaces. The method includes receiving at least one job from a known user of a multi-function device, and generating at least one workflow object, where the at least one workflow object is associated with the at least one job and the known user. The method also includes storing the at least one workflow object, receiving, at the multi-function device, authenticating information for the user, and identifying the at least one workflow object based at least in part on the authentication information. The at least one workflow object may also be presented or provided on a display.

According to an aspect of the invention, the method may include searching a plurality of stored workflow objects, using the authentication information, to identify the at least one workflow object. According to another aspect of the invention, the method may also include automatically creating a container associated with the known user, and associating the at least one workflow object with the container. Automatically creating a container may include automatically creating a container upon receipt of the at least one job from the known user. According to yet another aspect of the invention, the method includes identifying the container based at least in part on the authentication information. Additionally, the container may be presented on the display. Furthermore, providing the at least one workflow object on a display may also include prioritizing the placement of the at least one workflow object on the display based at least in part on the authentication information.

According to another embodiment, there is disclosed a method of associating content with a user. The method includes receiving at least one job from a known user of a device, associating the at least one job with the known user using metadata, and creating a workflow object corresponding to the at least one job, wherein the workflow object is associated with the metadata. The method also includes storing the workflow object and metadata, such that the workflow object and metadata may be automatically retrieved after the authentication of the known user at the device.

According to an aspect of the invention, the method may include creating a container and associating the container with the workflow object. According to another aspect of the invention, the method includes creating a container, and associating the container with the metadata. A container may also be automatically generated upon the creation of the workflow object. According to yet another aspect, the method includes searching the workflow object or metadata to determine if the workflow object or metadata are associated with an identified user of the device. The workflow object may also be displayed to the known user after the authentication of the known user at the device.

According to yet another embodiment, there is disclosed a device operable to print a document. The device includes a graphical user interface operable to receive authentication information from a user, and an object store, in communication with the graphical user interface. The object store is operative to use the authentication information to identify items associated with the user, and automatically present the items to the user on the graphical user interface, without a user instruction to do so, such that the items associated with the user are prominently displayed to the user on the graphical user interface.

According to an aspect of the invention, the items comprise a workflow object or a container. According to other aspects of the invention, the device may be a printer or a multi-function product capable of printing a document. According to another aspect of the invention, the object store is further operative to automatically generate at least one item associated with the user. Additionally, the object store may be operable to compare the authentication information with the automatically generated at least one item.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a Multi-function product (MFP), according to an embodiment of the present invention.

FIG. 2 shows containers, workflow objects, sub-containers, and their respective contents, according to an illustrative example of the present invention.

FIG. 3 shows a held jobs container, according to an illustrative embodiment of the present invention.

FIG. 4 shows a user container within the held jobs container of FIG. 2, according to an illustrative embodiment of the present invention.

FIG. 5 shows a home screen GUI, according to an illustrative embodiment of the present invention.

FIG. 6 shows a held jobs GUI, according to an illustrative embodiment of the present invention.

FIG. 7 shows a search GUI, according to an illustrative embodiment of the present invention.

FIG. 8 shows a search results GUI, according to an illustrative embodiment of the present invention.

FIG. 9 shows a PIN GUI, according to an illustrative embodiment of the present invention.

FIG. 10 shows a bookmark GUI, according to an illustrative embodiment of the present invention.

FIG. 11 shows a print/delete GUI, according to an illustrative embodiment of the present invention.

FIG. 12 shows a user-container GUI, according to an illustrative embodiment of the present invention.

FIG. 13 shows a print all GUI, according to an illustrative embodiment of the present invention.

FIG. 14 shows a user-specific confidential jobs GUI, according to an illustrative embodiment of the present invention.

FIG. 15 shows a workflow object print GUI, according to an illustrative embodiment of the present invention.

FIG. 16 shows a USB Drive GUI, according to an illustrative embodiment of the present invention.

FIG. 17 shows a USB drive subdirectory GUI, according to an illustrative embodiment of the present invention.

FIG. 18 shows a file deletion GUI, according to an illustrative embodiment of the present invention.

FIG. 19 shows a block diagram flow chart of a method for presenting customized GUIs, according to an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### I. Illustrative Multi-Function Module

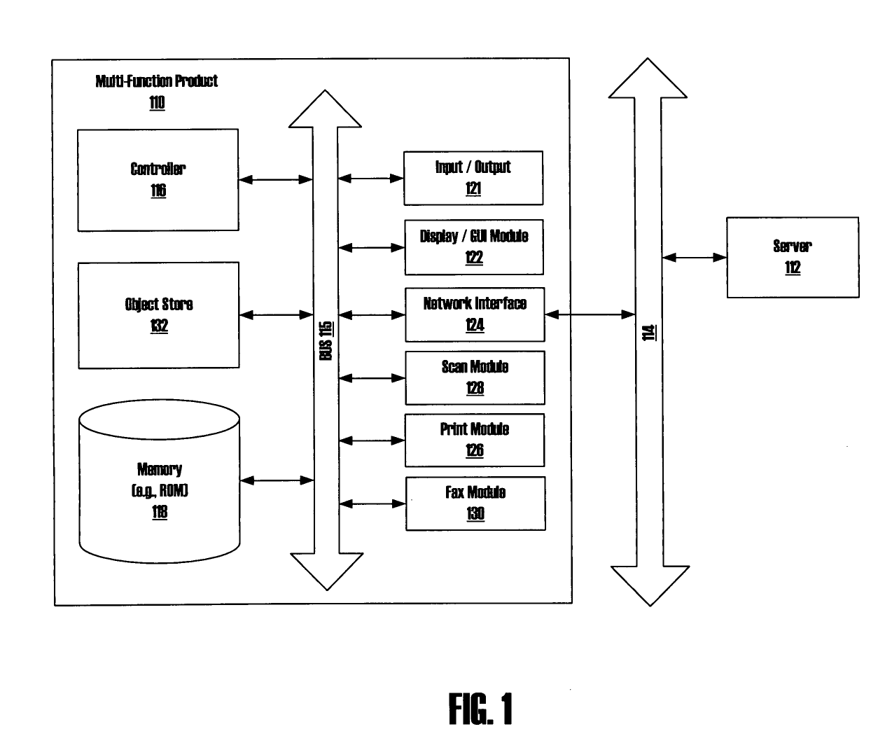

FIG. 1 shows a multi-function product (MFP) 110, according to an embodiment of the present invention. The MFP 110 may represent a multi-function device, such as a printer/scanner/fax/copier, or the control logic and/or control components within a multi-function device. The MFP 110 generally includes a controller 116, object store 132, memory 118, input/output 121, display/graphical user interface (GUI) module 122, network interface 124, print module 126, scan module 128, and fax module 130, each of which may communicate with each other via a bus 115.

The print module 126, scan module 128, and fax module 130 may implement the printing, scanning and fax functions, respectively, of the MFP 110. According to an embodiment of the invention, the print module 126 includes, for example, the necessary hardware and/or software that allow the MFP 110 to print documents, including those submitted to the MFP 110 via a network 114 and the network interface 124, and those stored local to MFP 110. Similarly, the scan module 128 may include, for example, the necessary hardware and/or software for scanning tangible documents on the MFP 110 and storing the scanned electronic documents in the memory 118, in a local attached memory device such as a flash drive, or in a remote memory on or in communication with the MFP 110 on the network 114. Likewise, the fax module 130 may include, for example, the necessary hardware and/or code for faxing electronic documents over a telephone line (not illustrated) or the like. The fax module 130 may also have an internal scanning device for scanning tangible documents or may work with the scan module 128 for scanning tangible documents and faxing documents over a telephone line.

According to an embodiment of the present invention, the print module 126, scan module 128, and fax module 130 may operate in conjunction with the controller 116, which may handle at least a portion of the processing required to effect the printing, scanning and faxing functions of the MFP 110. For instance, according to an embodiment of the invention, the scan module 128 may include a scan manager and the print module 126 may include a print engine, where the scan manager and print engine operate in conjunction with the controller 116 to handle printing and scanning processing, respectively, or the MFP 110. Similarly, the fax module 130 may include a fax engine and/or additional software and hardware for implementing fax functions, as known in the art, or may also utilize processing implemented by the controller 116 to effect fax functions.

It should be appreciated that the components described herein with respect to FIG. 1 may include computer-executable software running in conjunction with computer hardware. For instance, as illustrated in FIG. 1, and as described in detail below, the print module 126, scan module 128, fax module 130, and display/GUI module 131 may include computer executable programs (i.e., software) stored within one or more memories of the MFP 110 that are executed by the controller 116 to effect the functions described in detail herein. It will also be appreciated that the print module 126, scan module 128, and fax module 130 can include any suitable electronic and mechanical elements that together effect printing, scanning, and faxing functions, respectively, of the type that conventionally occur in commercially available multifunction machines. Such elements are well-understood by persons skilled in the art to which the invention relates. Therefore, details of the print module 126, scan module 128, and fax module 130, including the mechanical and other details of the manner in which they are constructed and communicate with one another and other elements to perform conventional printing, scanning, and faxing functions are not described in further detail herein.

The controller 116 may be a processor that executes computer executable programs with the aid of an operating system (not illustrated). According to other embodiments, one or more of the components illustrated in FIG. 1 may comprise hardware, such that the functions described herein are performed by hardware components. For instance, the controller 116, print module 126, scan module 128, fax module 130, and/or display/GUI module 122 may be implemented by an application-specific integrated circuit (ASIC), firmware, dedicated components, or the like, as are known in the art. Thus, it will be appreciated that the MFP 110 may be implemented in an entirely hardware embodiment, an embodiment combining software and hardware, or an embodiment comprised entirely of hardware. Additionally, one or more of the components illustrated in the MFP 110 of FIG. 1 may be combined to implement the methods and functions described in detail herein.

The MFP 110 is illustrated in FIG. 1 as being operatively coupled to (i.e., in communication with) the network 114, such as a LAN, WAN, or the like, via the network interface 124. The connection of the MFP 110 to the network 114 enables the MFP 110 to communicate with remote computing devices, such as one or more computers. According to an embodiment of the present invention, the MFP 110 may communicate with a server 112 via the network 114. The server 112 may be, for instance, a document server that works in concert with the MFP 110 for performing special functions on electronic documents that may be handled by the MFP 110. For example, the MFP 110 may work in concert with the server 112 for emailing electronic documents scanned by the MFP 110 to a desired electronic address accessible via the network 14. As another illustrative example, the MFP 110 may receive print requests from the server 112. Thus, the network 114 may represent a LAN that is in communication with a WAN, such as the Internet. The server 112 may also include specialized functions for setting up and controlling the operations of the MFP 110. It should also be apparent to those of ordinary skill that it is within the scope of the invention that the server 112 and MFP 110 maybe combined into a single unit operatively coupled to the network 114.

The MFP 110 includes at least one memory 118 operable to store data created or received by the MFP via the network 114 and the network interface 124. The memory 118 may include ROM, RAM, optical media, or other storage, as are well known in the art. According to an embodiment of the invention, the memory 118 is operable to store containers, work flow objects, and metadata, as described in detail below. Additionally, although illustrated as separate from the object store 132, at least a portion of the memory 118, or the entire memory, may be located within the object store 132. Thus, according to an illustrative embodiment, the object store 132 may store containers, work flow objects, metadata, and other data, local to and within the object store 132. According to one aspect of the invention, the memory 118 may also store data, such as work flow objects, uploaded to the memory 118 from a portable memory device via a portable memory interface (not illustrated) of the input/output 121. The portable memory interface may permit the MFP 110 to read/write (R/W) from a disk drive, R/W CD drive, flash media, USB device, or the like that is in communication with the MFP 110. For instance, the MFP 110 may receive a .PDF type document from a flash media inserted into the portable memory interface. According to one aspect of the invention, such a portable memory R/W device may also be a read-only device, such as read-only CD drive.

As is also shown in FIG. 1, the MFP 110 includes a display/GUI module 122 that controls the display of information on a display or GUI, which may be an input/output device of the MFP 110. The display/GUI module 122 includes numerous features described in detail herein to enable users to access, store and organize work flow objects, as is described in detail below. More specifically, the display/GUI module 122 works in conjunction with the object store 132 to enable users of the MFP 110 to retrieve, store and organize work flow objects that may be created, stored and/or transmitted to or from the MFP 110. The manipulation of such work flow objects is enabled by GUIs presented to the user via a display or GUI, and the storage and organization of such objects is handled by the object store 132 in conjunction with the controller 116. Additionally, as described in detail below, the display/GUI module 122 may operate in conjunction with the object store 132 to provide users with customized user interfaces based on the identity of a user.

According to an embodiment of the invention, a display or GUI of the MFP 110 may include an icon-based touch-screen (or similar) interface. It will be appreciated by those of ordinary skill in the art that the display or GUI may include any type of moveable-cursor-based interface, which would typically necessitate the use of a cursor-control device such as a mouse, a roller ball, or any similar cursor-control devices known by those of ordinary skill. According to one aspect of the invention, the GUI module 122 includes GUI software that operates in accordance with conventional windowing GUI paradigms.

It should be appreciated that the MFP 110 illustrated in FIG. 1 is according to an illustrative embodiment of the present invention. Therefore, one or more of the MFP 110 components described herein may be combined and/or placed external to the MFP 110, including remote from the MFP 110. Additionally, although described herein as a multi-function module, one or more of the components may be optional or unnecessary. For instance, the MFP 110 may represent a device that does not include a fax function, so that the MFP 110 may not include a fax module. Furthermore, although described herein as a MFP 110, according to an embodiment of the invention, the MFP 110 may alternatively have only a single or dedicated function, such as a scanning function requiring only the scan module 128. Other embodiments of the MFP 110 are possible. For instance, although the print module 126, scan module 128, fax module 130, and GUI module 131 are illustrated as independent components, each may be stored within one or more memories of the multi-function device 110, such as memory 118, and each may be stored in whole or part external to the MFP 110 and fetched into memory 118 on an as-needed basis. Other software elements of the types conventionally included in personal computers, such as an operating system and communications software, are also included but not shown for purposes of clarity.

### II. Work Flow Objects and Containers

According to an embodiment of the invention, the MFP 110 described with respect to FIG. 1 is operable to store and execute work flow objects and to organize workflow objects using containers. The identity of both workflow objects and containers are indexed by the object store 132 so that the object store 132 can identify and retrieve workflow objects and containers, and execute workflow objects. Both workflow objects and containers may be displayed to a user of the multi-function 110 module via icons, which may be selected by users to access the contents of containers and to execute workflow objects.

According to one aspect of the invention, work flow objects can include print jobs, confidential jobs, scan jobs, fax destinations, and other functions that may be executed by the MFP 110. It will be appreciated by those of ordinary skill in the art that workflow objects may replace traditional items, such as jobs, stored and executed by a multi-function product such as a printer/scanner/fax machine. In addition to items for execution, work flow objects may also include user profiles, settings and data associated with functions of the MFP 110. As an illustrative example, a work flow object may include a print job requested by a user via a computer communicating the print job to the MFP 110 via the network 114. As another illustrative example, a workflow object may be a stored fax number. In yet another illustrative example, a workflow object may be a user profile stored by the MFP 110.

According to an embodiment of the present invention, each work flow object shares a common format or data structure regardless of its function or use, and each contains the necessary information for its execution by the MFP 110. Thus, each workflow object includes all of the information necessary to display or identify the content, type or purpose of the workflow object, to execute the workflow object, and to manage its display and access. As will be explained in greater detail below, this allows a user to select a workflow object via the GUI, after which the workflow object is executed. For instance, each workflow object may include an icon displayable to a user via the GUI, which may be selected by the user. Upon selecting the workflow object, the appropriate function for the MFP 110 will automatically be performed. As an illustrative example, where the workflow object corresponds to a document to be printed, similar to a conventional print job, the document would be printed upon selection of the workflow object. According to another illustrative example, a workflow object may correspond to a user profile, and the user may select the workflow object to alter his or her profile.

According to an embodiment of the present invention, each workflow object may be associated with metadata that identifies characteristics of the workflow objects. As an illustrative example, the metadata may include a user associated with the workflow object, which may be used to automatically identify the workflow object after a user of the MFP 110 is authenticated. The metadata may also identify a module function to be performed, a PIN required for viewing or accessing it, an image (e.g., an icon) representing the workflow object, and the like. Metadata is associated with each workflow object, and may be stored and accessed by the object store 132, which is operable to index objects and to identify metadata associated therewith. Workflow objects may be generically stored by the MFP 110 without the need to organize workflow objects by their function, which provides the MFP 110 with flexibility in organizing, storing and providing access to such objects. Thus, multiple workflow objects corresponding to a particular user may be organized and/or presented together even though the workflow objects pertain to disparate functions of the multifunction MFP 110.

Workflow objects are organized by containers that may include one or more workflow objects. Containers, like workflow objects, may be represented by icons viewable by users of the MFP 110 via the GUI. Containers may be automatically generated upon the creation of a workflow object, or may be expressly generated by users. As an example, a container may be automatically created by the MFP 110 upon receipt of a document print request from a computer communicating with the MFP 110 via the network 114, where the container is based on the identity of the user's computer, or a user or other profile associated with the user's computer. For instance, the container may be automatically created and titled “JDoe” after a computer associated with user John Doe transmitted a print request to the MFP 110.

Containers, like workflow objects, may be associated with metadata that identifies characteristics (i.e., attributes) of each container. As an illustrative example, the metadata may include a user associated with the container, which may be used to automatically identify the container after a user of the MFP 110 is authenticated. Metadata associated with each container may be accessed by the object store 132, which is operable to index objects and to identify metadata associated therewith. Thus, referring again to the preceding example in which a container is automatically created, titled “JDoe”, and a print job (i.e., workflow object) is stored therein, a user may access that folder by walking up the MFP 110 and authenticating via the input of an ID, PIN, or the like. Upon identifying the user, the object store 132 may compare the user name to containers and workflow object, and identify that the “JDoe” container is associated with the user. As a result, the user may be presented with a GUI on which the “JDoe” container is prominently displayed. In this manner, one a user is authenticated the MFP 110 will automatically provide the user with simple access to the containers and workflow objects the user will likely access, obviating the need for the user to search for such information.

Containers may also be locally or remotely created by a user. For instance, a user may generate a container to store numerous workflow objects the user wishes to manage as a group. This may occur via a GUI of the MFP 110 or via a computer in communication with the MFP 110 via the LAN 114. According to another embodiment the invention, containers may be automatically generated in part by software and/or hardware in communication with the MFP 110, such as the Lexmark Document Solutions Suite (LDSS), a product of the assignee of the present application.

As described in detail below, one or more default containers may exist for each workflow object. For instance, when a workflow object is created at the request of a particular user, that workflow object may be automatically associated with a container corresponding to the user, which is the default container for the workflow object. However, workflow objects may also be associated with one or more containers. Thus, the same workflow object may be accessed from a plurality of containers. As an illustrative example, if a workflow object is a fax document created by a particular user, the workflow object may be included in a container associated with the user as well as a separate container that may contain all recent fax documents stored by the MFP 110. Because each workflow object is unique, each may include a unique shortcut, which may be a unique number associated with the workflow object. This permits a user to quickly identify the workflow object. According to an embodiment of the invention, the object store may index and/or store workflow objects by their unique shortcut. This also permits the object store to quickly retrieve workflow objects.

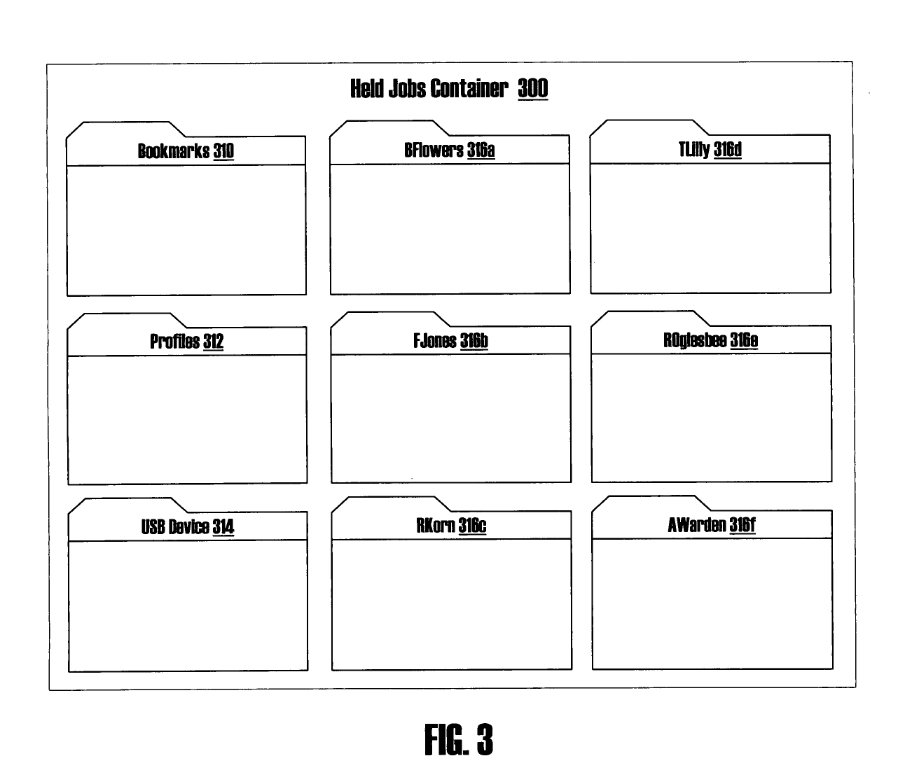

Referring once again to FIG. 1, the memory 118 is operable to store containers, work flow objects, and metadata, as instructed by the object store 132. Although illustrated as separate from the object store 132, at least a portion of the memory 118, or the entire memory, may be located within the object store 132. Thus, according to an illustrative embodiment, the object store 132 may store containers, work flow objects, metadata, and other data, local to and within the object store 132. Additionally, it will be appreciated that the display/GUI module 122 works in conjunction with the object store 132 to enable users of the MFP to create, retrieve, store and organize work flow objects and containers. Illustrative GUIs for performing such functions are described in detail with respect to FIGS. 3-18.

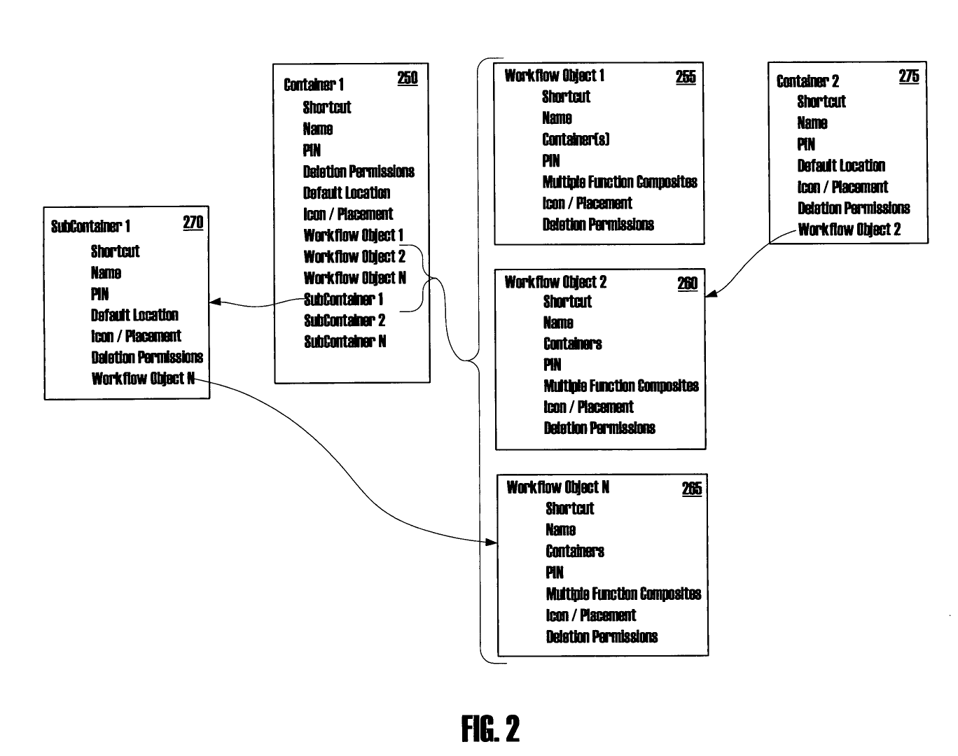

Next, FIG. 2 shows containers, workflow objects, sub-containers, and their respective characteristics or attributes, according to an illustrative example of the present invention. As described above, the object store 132 is operable to index and manage containers (including sub-containers) and workflow objects to implement the functions described herein. As such, the object store 132 is operable to search the attributes associated with each container and workflow object, and to store and manage the relationship between each. These attributes may be identified or defined by metadata corresponding to each container or workflow object and accessed by the object store 132. These functions will be readily apparent to one of ordinary skill in the art with reference to FIGS. 2-18.

As shown in FIG. 2, a container 1 250 may include a number of attributes, including a shortcut, name, PIN, deletion permissions, default location, icon and icon placement, and one or more workflow objects and/or one or more sub-containers. The container 1 250 may also have metadata (not illustrated) associated with it for defining and/or associating each of these attributes with the container 1 250. More specifically, the shortcut may be a unique number that identifies the particular container 1 250, and may be used by a user to identify the container 1 250. Additionally, the object store 132 may use the shortcut to index the container 1 250, and/or to associate attributes with the container 1 250. The container 1 250 may also include a name associated with the container 1 250. As described above, the name may be automatically generated, or alternatively may be created by a user. The container 1 250 may also include a PIN association to enable access to the container 1 250, if the container 1 250 is confidential and permits access to its contents only by authorized users. According to another aspect of the invention, the PIN association may also represent a user association, such that the container 1 250 may be accessed by those users associated with it that have rights to access the container 1 250. Similarly, a container may have deletion permissions that indicate those users that have rights to delete the container and/or change its attributes. The container 1 250 also includes an icon, illustrative examples of which are illustrated below. The icon attribute may also include placement attribute to indicate where the icon should be positioned on a GUI.

As shown in FIG. 2, workflow objects 255, 260, 265 within the container 1 250 also each include several attributes. Like the container attributes, these include a shortcut, a name, a PIN (or user association), an icon (and its location or placement), and deletion permissions. Workflow objects also include an attribute noting the one or more containers and/or sub-containers a workflow object is associated with. For instance, in the illustrative example of FIG. 2, workflow object 1 255, workflow object 2 260, and workflow object N 265 are each associated with container 1 250. However, workflow object 2 260 is also associated with container 2 275, and workflow object N is associated with sub-container 1 270. This illustrates that workflow objects may be associated with more than one container and/or sub-containers. Workflow objects also include multiple function composites, which indicate and provide the data and function of a workflow object. For instance, where a workflow object is a print job, the multiple function composites may include a copy and a fax composite, such that an icon may be provided to the user for selection that will permit the copying or faxing of the workflow objects.

Workflow objects may have one or more function composites to instruct the object store 132 and MFP 110 how a workflow object may be executed. Additionally, although the workflow objects are described above as including the data to implement a function, such as document data for printing or faxing, this data may be associated with the workflow object by metadata. Like containers, workflow attributes may be defined and/or associated with a workflow object by metadata (not illustrated), such that the object store 132 may index and identify the workflow attributes corresponding to a particular workflow object. The object store 132 may also search the container and workflow attributes. As is also shown in the illustrative example of FIG. 2, there may be one or more sub-containers associated with a container, where each includes the same attributes as a container. For instance, sub-container 1 270 includes a shortcut, name, PIN (or user association), an icon, deletion permissions, and one or more workflow objects. Although not illustrated in FIG. 2, a sub-container may also include additional sub-containers. The relationship of containers, sub-containers, and workflow objects will be further described below with reference to FIGS. 3-18.

It will be appreciated that the object store 132 may use container and workflow object attributes and metadata to associate user profiles with documents generated by each user. For instance, upon the creation of a workflow object by an authenticated or known network user, the object store may tag or otherwise associate that workflow object with the user. According to another embodiment, the object store 132 may create a user profile workflow object and associate it with other workflow objects and containers. This permits containers and/or workflow objects to be associated with a user, such that the MFP 110 can query the user profile to identify those containers and/or workflow objects associated with a user, rather than querying each workflow object and/or container to determine those associated with a user. This may permit accelerated search times when the MFP 110 or a user attempts to identify those containers or workflow objects associated with the user.

Next, FIG. 3 shows an illustrative held jobs container 300, according to an embodiment of the present invention. Note that the illustrative held jobs container 300 of FIG. 3 is intended only to illustrate the relationship between containers and workflow objects, and is not intended to represent a GUI displayed to a user of the MFP 110. As described above, the object store 132 of the MFP 110 may store containers and workflow objects in one or more memories local to or external to the object store 132. In FIG. 3, the held jobs container 300 represents the top level container stored by the object store 132, within which all other containers and all workflow objects are stored. Specifically, within the held jobs container 300 are nine (9) illustrative sub-containers 310, 312, 314, 316a-316f. FIG. 3 represents an illustrative container 300, so it will be appreciated that the sub-containers are intended to be illustrative only, and that a greater or fewer number of sub-containers may be located in the container 300. As shown in FIG. 3, the held jobs container 300 includes a bookmarks container 310, profiles container 312, a USB device container 314, and individual user containers 316a-316f. The user containers 316a-316f may be automatically named after users that have submitted workflow objects to the MFP 110. As described above, containers may include one or more sub-containers, and those one or more sub-containers may, in turn, include additional containers, etc., organized in a tree-type structure.

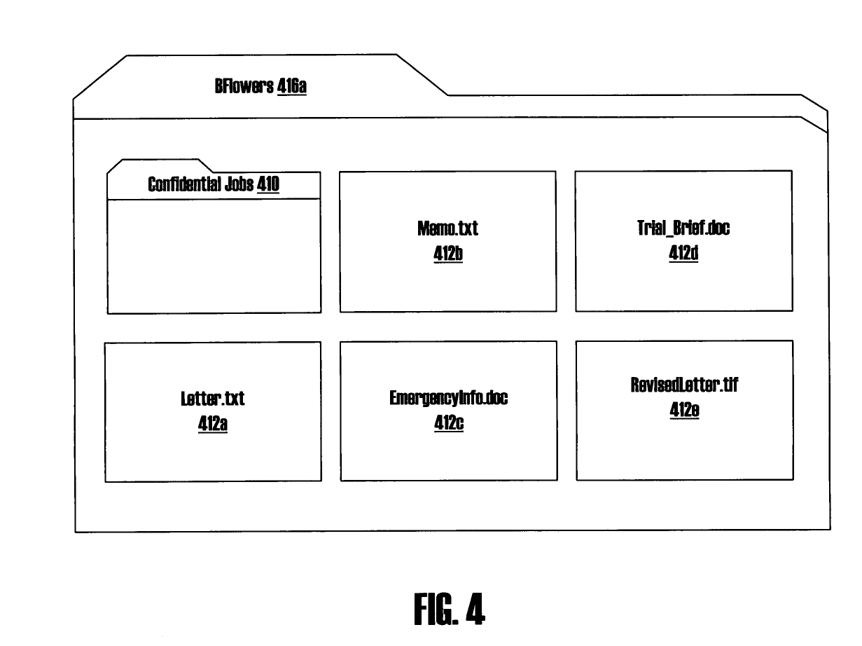

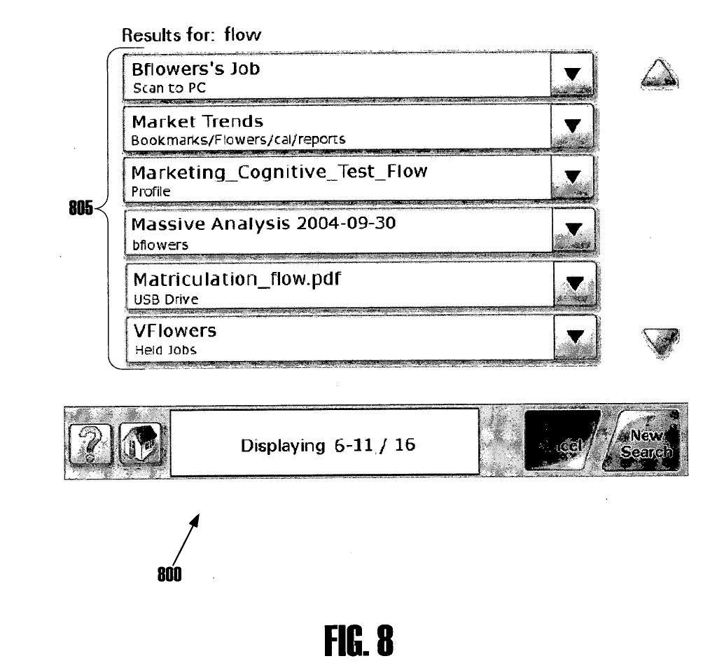

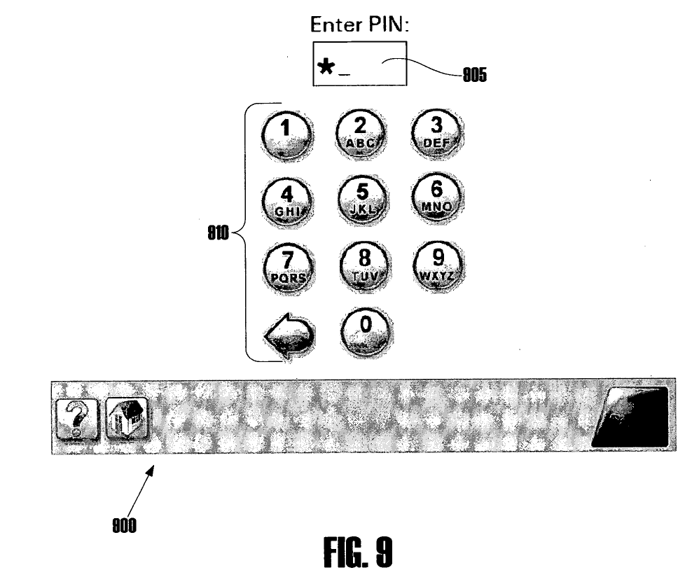

FIG. 4 shows a detailed view of a container for an illustrative user, BFlowers, which is the BFlowers container 316a of FIG. 2. As shown in FIG. 4, the BFlowers container 316a includes an additional container, confidential jobs 410, and five workflow objects 412a-412e. The confidential jobs container may include additional containers and/or workflow objects that only user BFlowers is permitted to access. As will be described below with reference to FIGS. 8 and 9, access to the confidential jobs container 410 may require a password, PIN, or the like, known only by user BFlowers. The five workflow objects shown in FIG. 4 represent documents in a variety of formats, which may be selected by a user for implementing a function of the multi-function module, such as printing copies of the objects 412a-412e. The workflow objects may have been stored within the BFlowers container 316a automatically, such as where they are received from a networked computer corresponding to user BFlowers, or input locally to the machine after user BFlowers logs into or otherwise identifies himself to the MFP 110. Alternatively, the workflow objects may be placed in the BFlowers container 316a only after an express instruction by a user.

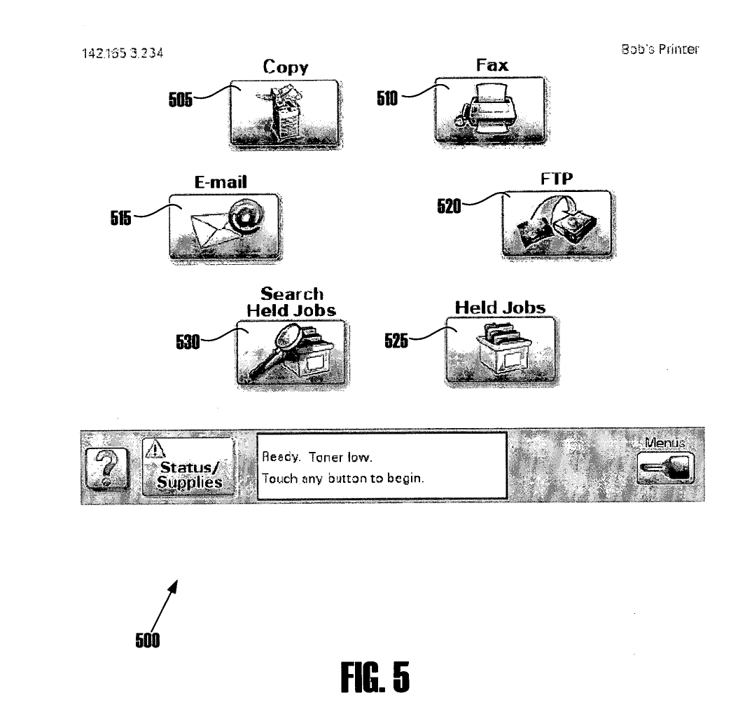

FIG. 5 shows a home screen GUI 500 that may be presented to users by the MFP 110, according to an embodiment of the invention. The home screen GUI 500 includes icons allowing a user to activate several basic functions of the MFP 110. According to one aspect of the invention, the icons may be selected by touch, where the display/GUI 122 is a touch screen display. Alternatively, the options may require the use of a cursor, one or more softkeys, or the like, as are known in the art. As shown in FIG. 5, these basic functions may include, for example, a faxing function represented by a fax icon 510, a copying function represented by a copy icon 505, a scan-to-email function represented by the email icon 515, and an FTP function represented by the FTP icon 520. Upon selecting the fax icon 510, the GUI will then provide a GUI that includes icons and associated fields for allowing the user to fax an electronic document stored by or scanned into the MFP 110 or over the network 114. Upon activating the copy icon 505, the GUI will advance to a graphical interface providing icons and fields for controlling the copying functions of the MFP 110. Similarly, upon activating the email icon 515, the GUI will provide an interface for allowing the user to type in an email message and attach electronic documents (either stored by the MFP 110, scanned by the MFP 110, stored on the server 112, or available over the network 114) to the email message, and send that email over to an electronic address over the network 114.

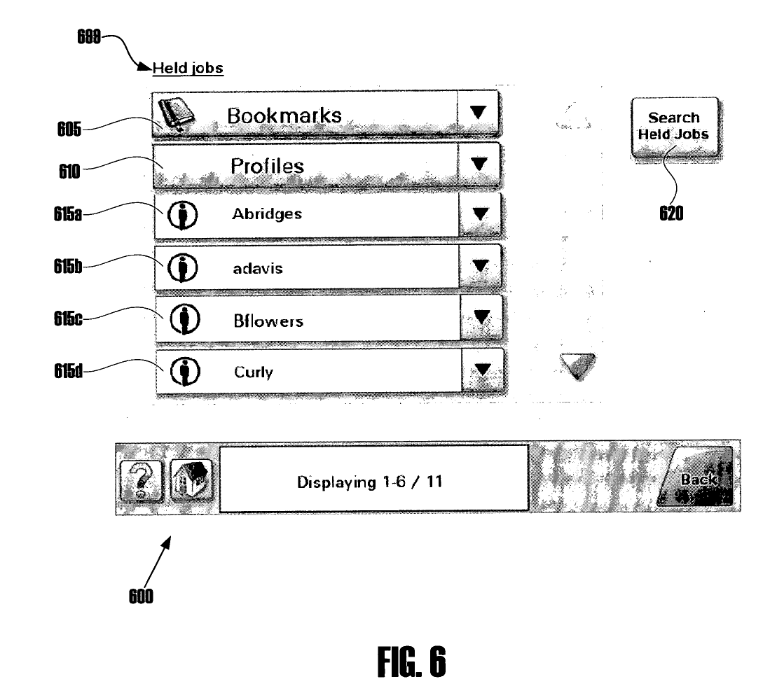

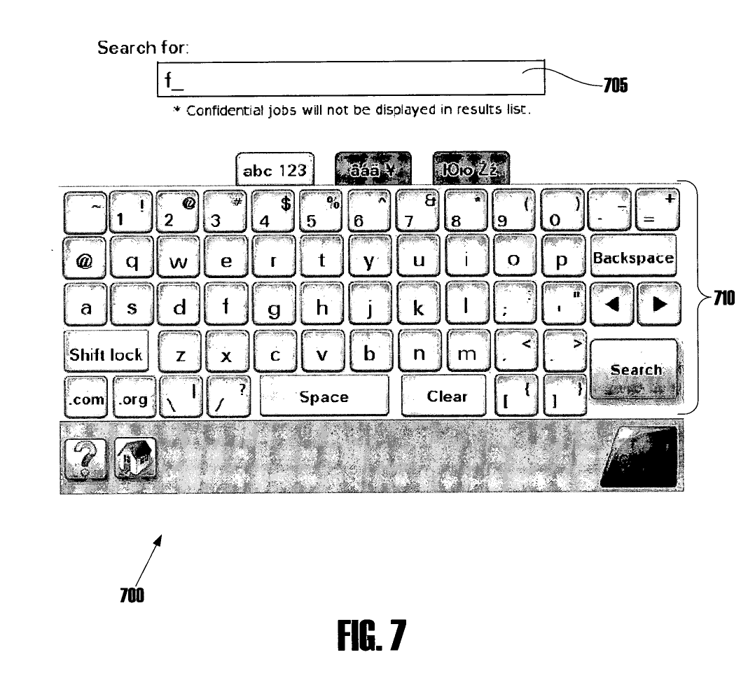

As shown in FIG. 5, the home screen GUI 500 also includes a search held jobs icon 530 and a held jobs icon 525. According to the illustrative embodiment of FIG. 5, the held jobs icon 525 represents a held jobs container, under which all workflow objects and containers are accessible. Thus, the home screen GUI 500 permits a user to access all of the containers and workflow objects managed by the object store of the MFP 110. According to an embodiment, the held jobs container may be the default container for all other containers, and the selection of the held jobs icon 525 will open a GUI showing the workflow objects and containers within it, as described below with respect to FIG. 6. According to one aspect of the invention, whenever the held jobs container includes any items, such as one or more workflow objects or containers, the search held jobs icon 530 will also be presented on the home screen GUI 500. The selection of the search held jobs icon 530 will open up a search GUI, as will be described in detail with reference to FIG. 7.

FIG. 6 shows a held jobs GUI 600, according to an illustrative embodiment of the present invention. The held jobs GUI 600 is presented to a user via the display/GUI of the MFP 110 after the user selects the held jobs icon 525 of the home screen GUI 500. The held Jobs GUI 600 includes one or more containers and/or workflow objects stored within the held jobs container. According to one aspect of the invention, for default containers and/or containers corresponding to external applications 605, 610 may be listed first, followed by icons for user-specific containers 615a-615d. As described above, the user-specific containers 615a-615d may be generated automatically based on the identity of a user's computer submitting a job to the MFP 110. According to one aspect of the invention, user-specific containers 615a-615d may be listed in alphabetical order. The user-specific containers 615a-615d may also be followed by workflow objects (not illustrated).

According to another aspect of the invention described in detail below, it will be appreciated that a user may only be presented with that user's container, as well as default containers, if the user authenticates (e.g., by entering a password, PIN, user ID, or the like) prior to viewing the held jobs GUI 600. According to one aspect of the invention, if a user has to authenticate to view the held jobs GUI 600, any workflow objects associated with the user may be placed within a container associated with the user, which may have a name matching the user's name, or matching a short form thereof. Additionally, the user's container may be placed in alphabetical order in a list of containers associated with users, where each is in alphabetical order based on a user's name. Alternatively, upon authenticating and accessing the held jobs GUI 600, a container matching the user may be listed just under the default and/or external application containers 605, 610.

More specifically, according to an illustrative example, a user may initially identify themselves to the MFP 110 via the entry of a username and password. After authentication, the MFP 110 may execute a comparison between the user's identity, such as using a unique number associated with the user, to object and/or container names used to store objects. This may be executed by examining a table of containers and/or workflow objects indexed by user, or may be accomplished by an examination of all containers and/or workflow objects to determine if they include an association with the user. If a match is made, the objects and/or containers may be prominently presented on a GUI, such as directly underneath the default containers, while the remaining items on the GUI are presented in a default or normal order. For instance, if a user submits a print job to a multi-function device, after approaching and authenticating at the device, the user may be presented with a list of held jobs, with a container for User1 listed at the top of an otherwise alphabetical list.

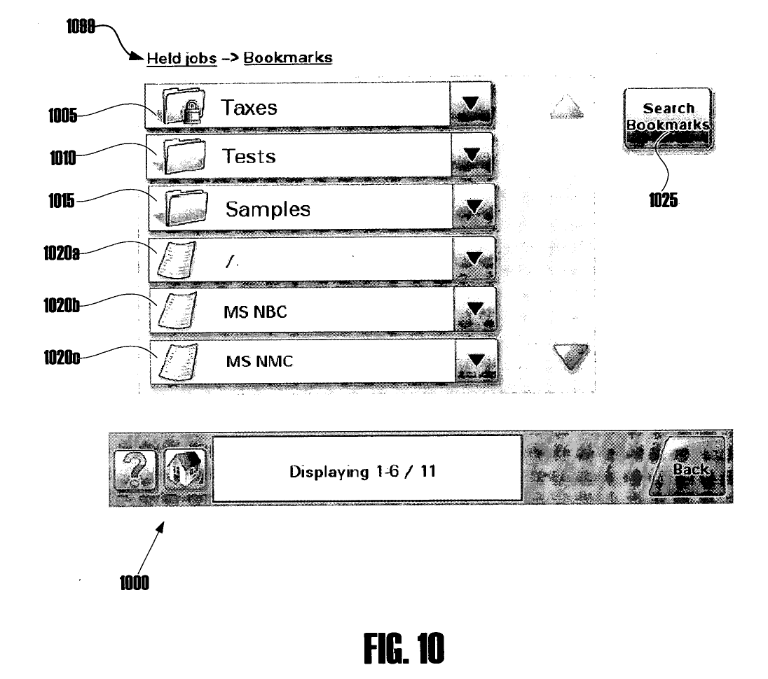

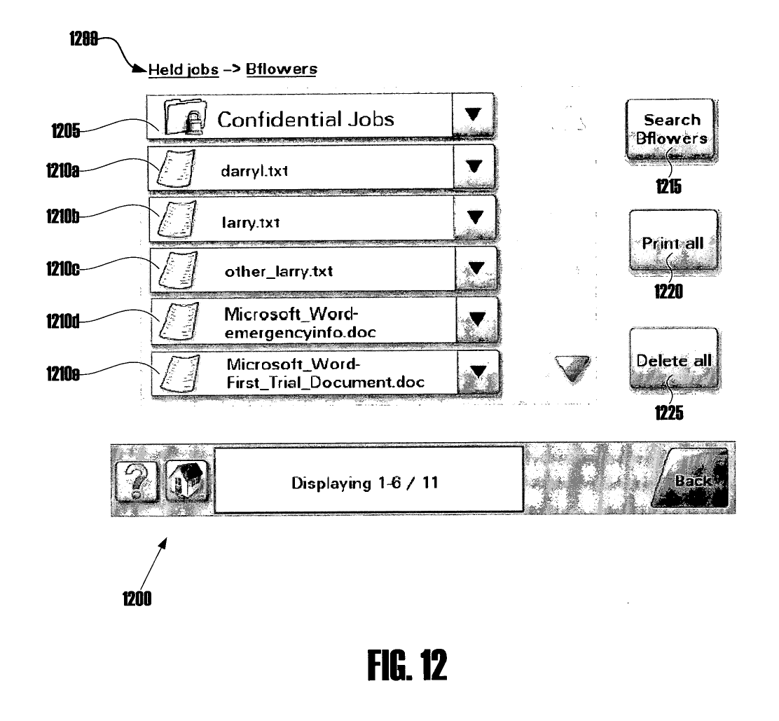

Referring again to FIG. 6, a user may select a container within the held jobs GUI 600 by selecting it, as may be accomplished via a touch screen, a mouse, or keys, as is known in the art. Selecting a container will in turn open up another GUI for that particular container, as will be illustrated below with respect to FIGS. 10 and 12. Though not illustrated in FIG. 6, according to another aspect of the invention, a user may also execute workflow objects presented by the held jobs GUI 600 by selecting the workflow object. Additionally, a user may select a search held jobs icon 620, which will direct the user to the same location as the search held jobs icon 530 of FIG. 5.

Next, FIG. 7 shows a search GUI 700, according to an illustrative embodiment of the present invention. The search GUI 700 permits a user to search through any containers and/or workflow objects within the held jobs container or sub-containers therein. To execute a search a user may enter a search term or terms in a search field 705 using a keyboard 710, which as illustrated in FIG. 7 may be similar to a conventional computer keyboard in layout to facilitate its use. Search terms may include usernames, job names, bookmark names, containers, profile names, shortcut names, and the like. The search term(s) may include any alphanumeric characters or symbols included within the illustrative keyboard 710. After inputting search term(s) by depressing or selecting a ‘search’ button, the object store 132 will retrieve containers and workflow objects matching the search term(s). The search results will be displayed to a user in a separate search results GUI 800, as shown in FIG. 8.

FIG. 8 shows a search results GUI 800, according to an illustrative embodiment of the present invention. The search results GUI 800 illustrates one or more workflow objects or containers the object store 132 identifies as matching the search term(s) input by a user via the search GUI 700. In the illustrative example shown in FIG. 8, the search term(s) are “flow”, and the search results 805 for “flow” are presented in the search results GUI 800 in alphabetical order. The search results may include containers or workflow objects, including usernames, job names, bookmark names, containers, profile names, shortcut names, and the like. In the illustrative example of FIG. 8, the search results 805 include a scan for a user having the name “Bflower's Job”, a bookmark stored within a “Flowers” container, a profile titled “Marketing_Cognitive_Test_Flow”, a document titled “Massive Analysis 2004-09-30” created by bflowers, a document on a local USB drive titled “Matriculation_flow.pdf”, and a container of held jobs for user “BFlowers”.

A user may execute any of the workflow objects presented by the search results GUI 800 by selecting the workflow object, as will be described in further detail below. Additionally, because a large number of search results may match the search term(s), the search results GUI 800 may include up and down arrows that operate in a page up/page down fashion until the last entry in the direction of travel is shown. For instance, where the search results GUI 800 may show six search results at once, if there are 16 search results to be displayed, the first screen may show the first six search results, 1-6, with a grayed-out up arrow. Pressing the down arrow may display results 6-11 (i.e., the last search result in the previous screen is repeated), while pressing the down arrow again displays results 11-16. The search results GUI 800 may also include at least button permitting a user to execute a new search, such that the selection of the button will return the user with the search GUI 700 shown in FIG. 7.

It will be appreciated that although certain containers and/or workflow objects may match the search term(s) input by a user, one or more of the containers and/or workflow objects may be confidential. According to an embodiment of the invention, confidential containers and/or workflow objects will not be displayed to users whose rights do not include the rights to access those confidential items. Thus, the display of search results on the search results GUI 800 may only be effected after the matching search results are compared against the rights of the user to view such results. According to one aspect of the invention, this comparison may be implemented by the object store 132. For instance, a user may not be able to view a confidential workflow object for a print job that was created by another user and saved as confidential, such that the creator of the work flow object may be the only person to view and execute it other than an administrator having rights to access any and all jobs and containers.

According to another embodiment of the invention, confidential containers and/or workflow objects may be displayed to all users be default regardless of the user's identity. However, to access those search results a user may be required to enter a personal identification number (PIN). Therefore, each workflow object and/or container may be associated with a permission list that includes PIN numbers against which user-input PINs may be compared to determine whether access to a workflow object or container should be granted. FIG. 9 shows an illustrative PIN GUI 900 via which a user may enter a PIN number. The PIN number may be used to identify the user and authorize the user to view a particular workflow object or container. PIN entry may be useful to identify walk-up users of the device. However, where the containers and/or workflow objects are remotely accessible by authenticated users, e.g., users on the network 114, a PIN may not be required. Referring again to FIG. 9, a user may enter a PIN using a keypad 910. The PIN may be displayed in a PIN entry window 905 as it is entered. Alternatively, the PIN entry window 905 may display asterisks in place of the PIN numbers entered by a user so as to hide the entered PIN number from onlookers. It will be appreciated to those of ordinary skill in the art that the PIN may comprise any number of numbers, and may also include letters, such that the keypad 910 may be similar to the illustrative keyboard 710 of the search GUI 700.

Referring again to the held jobs GUI 600, the held jobs container may include a bookmark container 605. According to an aspect of the invention, the bookmark container 605 may include popular, commonly accessed containers and workflow objects. Upon selecting the bookmark container 605, a bookmark GUI 1000 is provided to the user. As with any container, the bookmark container 605 can include sub-containers as well as workflow objects that, when selected, initiate an action, such as printing a page. The workflow objects within the bookmark container may be referred to as bookmarks. In the illustrative example of FIG. 10, the bookmark GUI 1000 includes three containers 1005, 1010, 1015 and at least three workflow objects (or bookmarks) 1020a, 1020b, 1020c. The bookmark GUI 1000 may also include at least button permitting a user to execute a search of the bookmarks 1025, which may direct the user to the search GUI 700 shown in FIG. 7, which may then be used to search only containers and workflow objects within the bookmark container 605.

As with any screen listing containers and workflow objects, containers may be displayed first, followed by workflow objects. As also illustrated in the bookmark GUI 1000, confidential items, such as the confidential container “Taxes” 1005, may be illustrated with an icon representing a folder and a lock. Containers 1010, 1015 that are not confidential may be illustrated with an icon representing a folder. Both containers and workflow objects may be represented based on their type. For instance, where workflow objects represent documents that may be printed, they may be represented by an icon representing a piece of paper. As another example, where a container is associated with a particular user profile, it may be represented by an icon representing a person, such as the icons for user-specific containers 615a-615d in the held jobs GUI 600 described above.

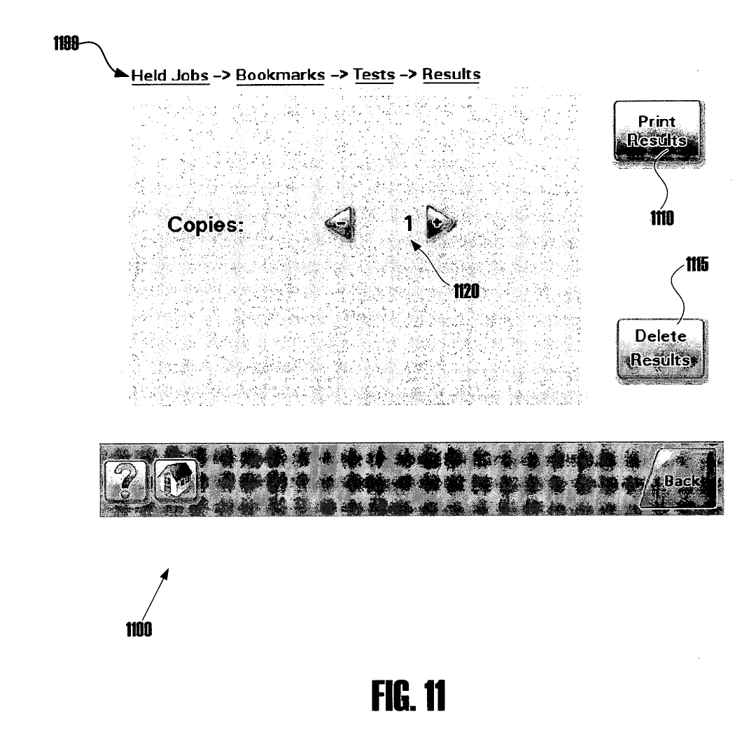

When a user selects a container or workflow object from the bookmark GUI 1000, the MFP 110 may display the contents of the container or execute the bookmark. As an illustrative example, a “Results” workflow object may represent a document. The “Results” workflow object may have been accessed via a selection of the “Tests” container 1010, within which it was presented as a workflow object. According to an embodiment of the invention, bookmarks may be printed or deleted. Thus, upon its selection by the user, the MFP 110 will execute the workflow object and the user may be presented with the print/delete GUI 1100 shown in FIG. 11. The print/delete GUI 1100 includes a print icon 1110 and a delete icon 1115, which allows the user to print or delete the workflow object. As illustrated, each of the icons 1110, 1115 may include the name of the workflow object “results”. A user is also presented with a copy count 1120 that may be increased or decreased using one or more keys, such as the “+” and “−” icons shown in FIG. 11. When the user wishes to print the desired number of copies, the user will select the print icon 1110 and the MFP 110 will print the number of copies indicated by the copy count. Alternatively, selecting the delete icon 1115 will result in the complete deletion of the “results” workflow object. Thus it may no longer be accessed from any containers, including the bookmark container 605, and the “tests” container 1010.

Next. FIG. 12 shows an illustrative user-container GUI 1200, according to an illustrative embodiment of the invention. The user-container GUI 1200 may have been accessed, e.g., via a selection of a user container from the GUI 600 shown in FIG. 6. According to another embodiment of the present invention, upon authenticating at the MFP 110, a user may be automatically presented with their user-container via the user-container GUI 1200. In particular, the user-container GUI 1200 illustrated in FIG. 12 is the user-specific container 615c corresponding to user “Bflowers”. The user-specific container GUI 1200 is similar in layout to other GUIs illustrating containers and/or workflow objects. As shown in FIG. 12, a user may use the user-specific GUI 1200 to access a sub-container 1205 or one or more workflow objects 1210a-1210e. The user-container GUI 1200 may also include at least one button permitting a user to execute a search of the user-specific container 615c, which may direct the user to the search GUI 700 shown in FIG. 7, which may then be used to search only containers and workflow objects within the user-specific container 615c.

As shown in FIG. 12, whenever two or more non-confidential workflow objects, e.g. print jobs, are present at the level of a container displayed via a GUI, that GUI may provide a “Print all” icon and a “Delete all” icon. Thus, as shown in the user-specific container GUI 1200, a “Print all” icon 1220 and a “Delete all” icon 1225 are provided to permit the printing and/or deletion of all of the workflow objects within the user-specific container 615c. According to another aspect of the invention, the “Print all” icon 1220 and “Delete all” icon 1225 also permit the printing and/or deletion of all of workflow objects within sub-containers of the user-specific container 615c. However, the print all and delete all functions may not include any confidential workflow objects stored within a confidential folder within the container. According to one aspect of the invention, whenever one or more workflow objects within a container, such as the user-specific container 615c represented by the user-container GUI 1200, are confidential, a “confidential jobs” icon 1205 representing a confidential folder within the container becomes the first selection in the container and workflow object list. Non-confidential jobs are listed as the next selections. Thus, to print or delete confidential workflow objects requires a user to first select the confidential jobs icon 1205, and may require the input of a PIN or similar password, as described above with respect to FIG. 9.

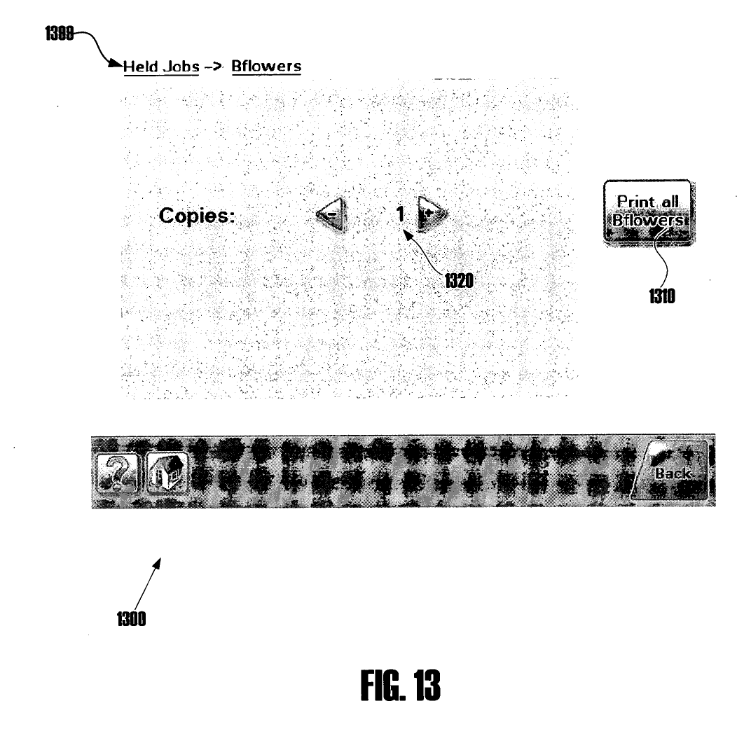

If a user selects the print all icon 1220, a Print All GUI 1300 is presented to the user, as is shown in the GUI 1300 of FIG. 13, according to an embodiment of the present invention. The Print All GUI is similar to the print/delete GUI 1100 for a single work flow object, except that a print all button 1310 includes the container name instead of a workflow object name, and the number of copies 1320 adjustable by a user is applied to all of the workflow objects printed from the container. Additionally, because a delete all button exists at the higher level, it does not appear in the print all GUI 1300.

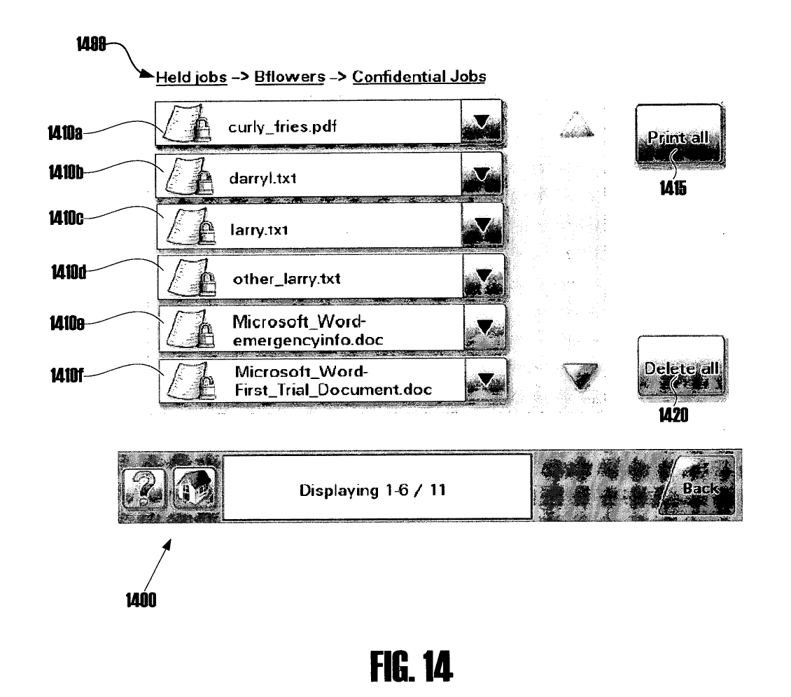

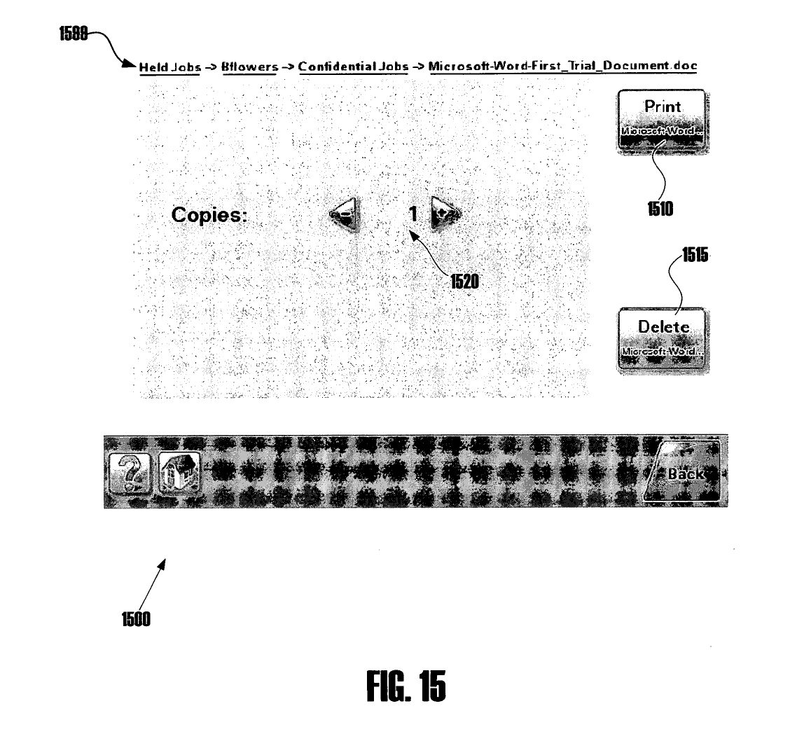

Continuing with the illustrative user-container GUI 1200 shown in FIG. 12, if the confidential jobs container 1205 is selected, a user-specific confidential jobs GUI 1400 will be presented to the user after the user enters a PIN or similar password, as described with respect to FIG. 9. The user-specific confidential jobs GUI 1400 may display each of the workflow objects and/or confidential folders of the user, including workflow objects 1410a-1410f in illustrative example of FIG. 14. Those workflow objects 1410a-1410f in the user's confidential container can be selected for individual printing. For instance, as shown in the Workflow Object Print GUI 1500 shown in FIG. 15, upon the selection of a workflow object from the user-specific confidential jobs GUI 1400, the user can delete the workflow object via selection of the delete icon 1515, or print the workflow object via the print icon 1510. The user is also presented with a copy count 1520 that may be increased or decreased using one or more keys, such as the “+” and “−” icons shown in FIG. 11. When the user wishes to print the desired number of copies, the user will select the print icon 1510 and the MFP 110 will print the number of copies indicated by the copy count.

Navigating through each of the above-described GUIs may be achieved using ‘back’ buttons on the GUIs, and/or using the directory links at the top of each GUI. Thus, each of the underlined directory links 699, 1099, 1199, 1299, 1499, 1599 will permit a user to navigate to the GUI representing the location identified by the directory link, similar to an HTML link on a web page. Further, each of the GUIs of the present invention may include such directory links. As an illustrative example, selecting on the ‘Held Jobs’ portion of the directory link 1199 in the print/delete GUI 1100 will navigate the user to the held jobs GUI 600, while selecting the ‘Bookmarks’ portion of the directory link 1199 in the in the print/delete GUI 1100 will navigate the user to the bookmark GUI 1000.

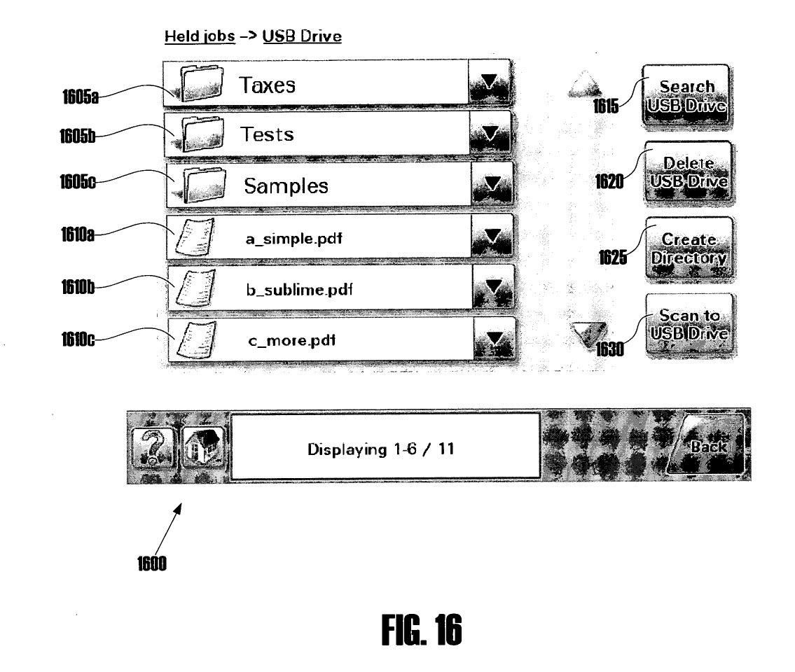

The MFP 110 of the present invention may also present the user with GUIs for illustrating those containers and/or workflow objects stored external to the MFP 110. For instance, as shown in FIG. 16, the MFP 110 may display a USB Drive GUI 1600 for displaying the containers and workflow objects stored within a storage device, such as a flash drive, connected to the MFP 110 via a USB. Thus, upon attaching a USB device to the MFP 110, the controller 116 may identify the device. Upon requesting the USB Drive GUI 1600 the object store will read the contents of the USB device and display the contents via the USB Drive GUI 1600. In the illustrative example of FIG. 16, the USB Drive GUI 1600 includes three containers 1605a-1605c and at least three workflow objects 1610a-1610c. Similar to the bookmark GUI 1000, the USB Drive GUI 1600 may also include at least one search button 1615 permitting a user to execute a search of the USB Drive containers and workflow objects, which may direct the user to the search GUI 700 shown in FIG. 7, which may then be used to search only containers and workflow objects within the USB drive.

The USB Drive GUI 1600 also includes a delete icon 1620 permitting a user to delete all contents of the USB device. Although not illustrated, upon selecting a delete function via the selection of the delete icon 1620, a user may be requested to confirm deletion. As shown in FIG. 16, a user may also create a new directory via the selection of the create directory icon 1625. This may permit the creation of a container stored local to the MFP 110 and managed by the object store to which the USB contents may be copied. According to another aspect of the present invention, this may include the creation of a directory, or container, local to the USB drive. As shown in FIG. 16, the user may also scan to the USB drive via selection of the scan icon 1630. This permits, for instance, the storage on the USB device of a scanned image of a document scanned by the MFP 110.

Selecting a “Scan to [x]” button will scan and image and store it in the [x] directory. Default values for the settings may be factory default values for scan parameters, and the default file name for a scan may be “Scanned-image”. However, if an image with the same name exists in the directory, a dash followed by a number may be appended to the end of the name. Thus Scanned-image.pdf may be the default for the first scan. If tried again, it would become Scanned-image-1.pdf, and then the third try it would be Scanned-image-2.pdf.

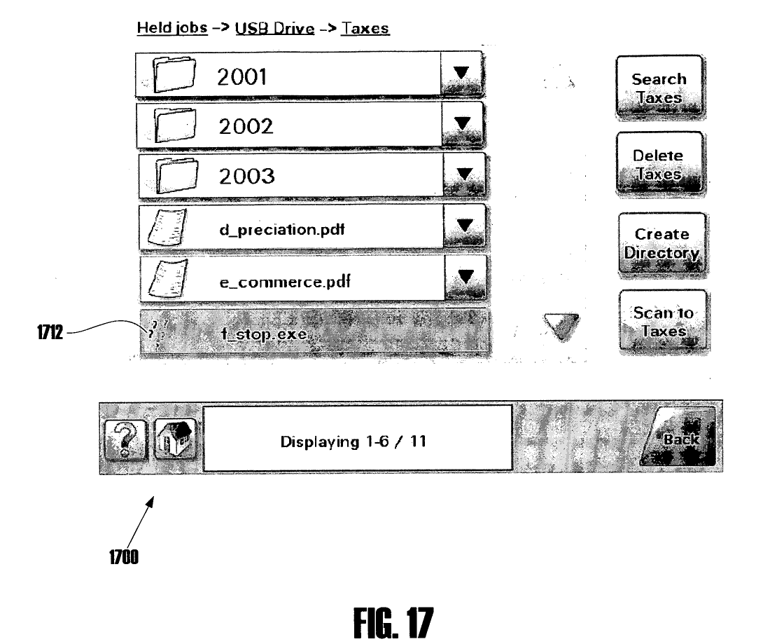

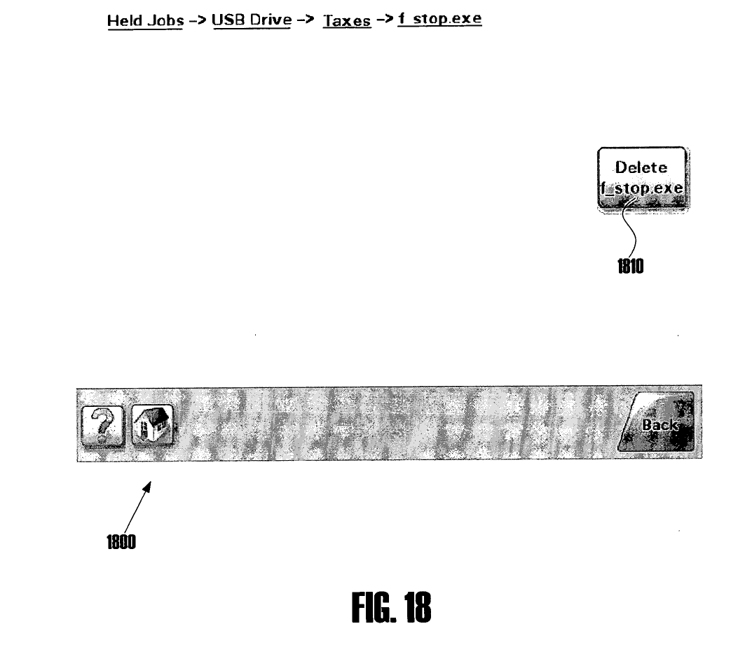

As shown in the illustrative USB Drive Subdirectory GUI 1700 of FIG. 17, a file 1712 within the USB device may have an extension that is not recognized by the MFP 110. According to one aspect of the invention, the file is illustrated in the GUI 1700 but may not be selected by a user. According to an alternative aspect of the invention, the file may not be displayed by the GUI 1700. According to yet another aspect of the invention, the file may be displayed and selected, wherein the selection of the file permits the deletion of the file via the selection of a deletion icon 1810 on a file deletion GUI 1800, as shown in FIG. 18.

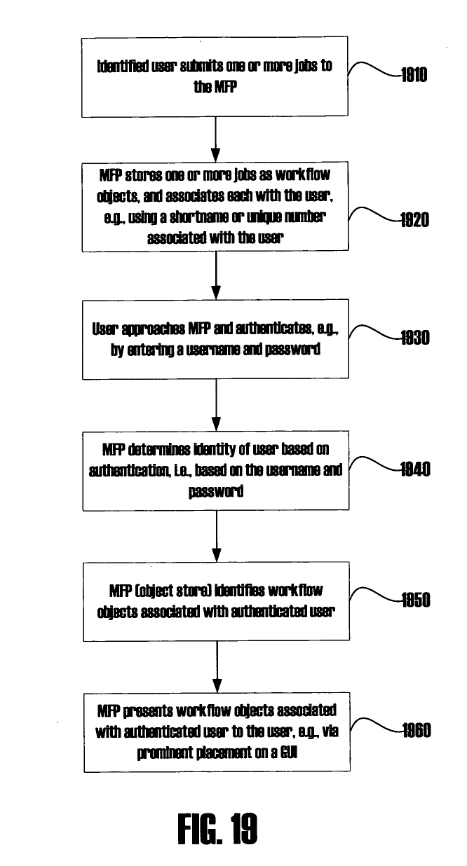

FIG. 19 shows a method implemented by a MFP 110 according to an embodiment of the present invention to present a user with a customized GUI based on the user's identity. As shown in FIG. 19, a user may submit one or more documents, files, or other jobs to an MFP 110 (block 1910). This submission is associated with the user, as it may occur remotely from a network-identified computer associated with the user, or it may occur at the MFP by a user that has identified themselves to the MFP 110, for instance, through the use of a PIN, username, and/or password. The MFP 110 will then store the documents, files, or other jobs as workflow objects and will associate each with the user (block 1920), for instance, through the use of metadata. According to an embodiment, this may occur through listing the workflow object within a user profile or container associated with the user. Alternatively, this may also occur through associated the user with the workflow object via metadata associated with that workflow object.

Once the user approaches the MFP 110, the user will authenticate is the user has not already done so (block 1930). As described above, this may occur via the entry of a PIN, user name, and/or password, or the like. After authentication, the MFP 110 will identify the identity of the user (block 1940) and can execute a comparison between the user's identity, such as using a unique number associated with the user, to identify workflow objects and/or containers associated with the user (block 1950). If a match is made, the objects and/or containers may be prominently presented on a GUI (block 1960), while the remaining items on the GUI are presented in a default or normal order. For instance, if a user submits a print job to a multi-function device, after approaching and authenticating at the device, the user may be presented with a list of held jobs, with a container titled with the user's name listed at the top of the otherwise alphabetical list.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for presenting user-customized graphical user interfaces, comprising:
receiving at least one job from a known user of a multi-function device;
generating at least one workflow object, wherein the at least one workflow object is associated with the at least one job and the known user;
storing the at least one workflow object;
receiving, at the multi-function device, authenticating information for the user;
identifying the at least one workflow object based at least in part on the authentication information; and
providing the at least one workflow object on a display.

2. The method of claim 1, further comprising searching a plurality of stored workflow objects, using the authentication information, to identify the at least one workflow object.

3. The method of claim 1, further comprising automatically creating a container associated with the known user, and associating the at least one workflow object with the container.

4. The method of claim 3, wherein automatically creating a container comprises automatically creating a container upon receipt of the at least one job from the known user.

5. The method of claim 3, further comprising identifying the container based at least in part on the authentication information.

6. The method of claim 5, further comprising providing the container on the display.

7. The method of claim 1, wherein providing the at least one workflow object on a display comprises prioritizing the placement of the at least one workflow object on the display based at least in part on the authentication information.

8. A method of associating content with a user, comprising:
receiving at least one job from a known user of a device;
associating the at least one job with the known user using metadata;
creating a workflow object corresponding to the at least one job, wherein the workflow object is associated with the metadata; and
storing the workflow object and metadata,
such that the workflow object and metadata may be automatically retrieved after the authentication of the known user at the device.

9. The method of claim 8, further comprising creating a container and associating the container with the workflow object.

10. The method of claim 9, wherein the container is automatically generated upon the creation of the workflow object.

11. The method of claim 8, further comprising creating a container, and associating the container with the metadata.

12. The method of claim 1 1, wherein the container is automatically generated upon the creation of the workflow object.

13. The method of claim 8, further comprising searching the workflow object or metadata to determine if the workflow object or metadata are associated with an identified user of the device.

14. The method of claim 8, further comprising displaying the workflow object to the known user after the authentication of the known user at the device.

15. A device operable to print a document, comprising:
a graphical user interface operable to receive authentication information from a user; and
an object store, in communication with the graphical user interface, wherein the object store is operative to:
use the authentication information to identify items associated with the user; and
automatically present the items to the user on the graphical user interface, without a user instruction to do so, such that the items associated with the user are prominently displayed to the user on the graphical user interface.

16. The device of claim 15, wherein the items comprise a workflow object or a container.

17. The device of claim 15, wherein the device is a printer.

18. The device of claim 15, wherein the device is a multi-function product capable of printing a document.

19. The device of claim 15, wherein the object store is further operative to automatically generate at least one item associated with the user.

20. The device of claim 19, wherein the object store is operable to compare the authentication information with the automatically generated at least one item.
